(19) United States
(12) Patent Application Publication
(10) Pub. No.: US 2003/0062124 A1
(43) Pub. Date: Apr. 3, 2003

(54) Composition for the cold preparation of composite materials for adhesive bonding

(76) Inventors: Stephane Fouquay, Mont Saint Aignan (FR); Jean-Pierre Lallier, Herblay (FR); Michel Miskovic, Compiegne (FR)

Correspondence Address: Robert M. Schulman, Hunton & Williams, Suite 1200, 1900 K Street, N.W., Washington, DC, 20006-1109, US

(21) Appl. No.: 09/938,539

(22) Filed: Aug. 27, 2001

(51) Int. Cl. C09J 1/00

(52) U.S. Cl. 156/326; 156/331.4

(57) ABSTRACT

The present invention relates to a liquid composition for the cold preparation of laminate composite materials so as to confer to them, without preliminary sanding or abrasion, a surface state favorable to adhesive bonding with polyurethane type adhesives comprising

(a) at least one polar aprotic solvent (TPA);

(b) at least one ether (TE) selected from the family of ethers, ether-esters, ether-ketones having: a molar volume less than 200 and preferably less than 160, a molecule devoid of hydroxyl function, and

(c) at least one activator (TA) comprising at least one reactive nitrogenous function of the —NH₂ and/or —NH— type of molar volume less than 100.

### CROSS REFERENCE TO RELATED APPLICATIONS

The present application hereby incorporates by reference FR 00/10110 and FR 01/05863.

### BACKGROUND OF THE INVENTION

(i) Field of the Invention

The present invention relates to a liquid composition useful in the cold preparation of composite materials in order to confer to them without preliminary sanding or abrasion a surface state favorable to adhesive bonding with the aid of polyurethane type adhesives.

(ii) Description of the Related Art

Composite materials principally comprise two components, an unsaturated polyester-type resin and at least one reinforcing filler comprised of glass fibers.

These composite materials are most often found either under the form of a mass composites or laminated composites.

The mass composite materials principally comprise three components: an unsaturated polyester resin UP for about 30% by weight and two types of fillers (about 70%), a reinforcing filler comprised of generally glass fibers (about 20%) and an inert packing filler (about 50%) intended to reduce the cost of the material often comprised of calcium carbonate. Naturally, other additives can be added, for example thermoplastic additives such as polyvinyl acetate (PVAc), on the one hand to limit the shrinkage of the resin during the polymerization and, on the other hand, to lead to smooth surfaces; there can equally be added internal mold-release agents; for example zinc or calcium stearates are equally added in order to facilitate the release of the pieces.

These composites are products that are molded either cold and/or under a vacuum, thus spoken of as contact Polyester, or by heat and they are thus designated by a series of abbreviations of American origin such as SMC (Sheet Molding Compound), BMC (Bulk Molding Compound), RTM (Resin Transfer Molding), AMC (Adapted Molding Compound), RIM (Resin Injection Molding), etc . . .

The automobile industry is representative of the users of this type of composite materials. This industry uses in effect more and more frequently these materials to replace the sheet metal of the body in order to reduce the weight, to resolve corrosion problems, but equally to obtain greater liberty in the drawing up of new forms. The joining by adhesive bonding is then the only means of available assembling, the classic techniques such as fastening and bolting not being adapted. Besides, the finishing of the surface after painting must present a smooth appearance identical to that of the sheet metal, the two materials being present on the vehicle.

The laminated composite materials of the GRP type (Glass Reinforced Plastics) or FRP type (Fiber Reinforced Polymers) designate any material or composite piece including an unsaturated polyester type resin matrix and reinforcement fibers, notably glass fibers. In the manufacture of the GRP piece, the creation of the lamination is begun following the laying and during the hardening phase of the so called gel coating. The operation consists of creating on the gel coat a series of successive reinforcing resin layers to obtain after ebullage a compact and hard assembly that gives to the pieces its structural properties.

The reinforcement can be in the form of glass mat, cut glass threads or glass tissues, the choice of the good reinforcement permitting one to give the optimal structural properties to the molded object. Fibers based on synthetic polymers (in roving, mat or non-woven cloth form, inorganic materials or compounds such as boron, carbon (graphite) or silica (in roving or mat form) are equally used. Among the glass fiber reinforcements used the most currently and known to a person skilled in the art, there can be singled out:

glass mat or web

cut fiber mat

Roving or Stratifil,

Roving tissue

fabric or tissue

sandwich materials

For a lamination resin, the choice of reinforcement is made according the mechanical characteristics sought after, these depending notably on the number of layers, the thickness of the laminate and its amount of glass.

The resin can be manually applied, by brush, by spraying or by injection, the choice of the technique varying according to the form, the size and the number of pieces to be produced.

The polyester resins are widely used and give excellent results in the framework of contact molding. For certain applications requiring specific mechanical performances, there are also used vinyl-ester resins and epoxy resins. Whatever type of resin is used, this cold transformation constitutes for the molded resin an irreversible passage from a liquid state to a solid state during which, by chemical reaction, the material acquires its final characteristics. This transformation is therefore an important stage which is not only governs the behavior and the properties of the molded piece but also its surface state.

The leisure boating industry is representative of the users of this contact molding technique. This open mould lamination process carried out manually or by simultaneous spraying of the glass and of the resin is equally called low pressure lamination. This industry frequently uses the unsaturated polyester resin based laminates in order to make boat hulls, which are to then to receive, before the bridge pause, a certain number of bulkheads which can be positioned differently according to the desired model. The joining by adhesive bonding is thus the only available means of assembly, the classical techniques such as fastening and bolting not being adapted.

A polyurethane is generally used, which is of the mono-component (PU1K or HMPUR) or bi-component (PU2K) type.

The problem posed by the quality of the adhesive bond between two pieces, where at least one of them is of a composite material, is thus a necessary one when there are concerns about minimizing the costs of preparation of the surfaces to bond.

The quality of the adhesive bond is determined by tensile and shearing strength rupture resistance tests according to the so-called hold method defining breaking patterns. It is necessary to distinguish the adhesive rupture (AR), considered to be bad, when the adhesive remains integral with a support, the cohesive rupture (CR) considered to be good, where the rupture takes place in the middle of the adhesive layer and the support rupture (SR) independent of the adhesive, with its variable so-called support delamination (DEL), it, excellent. These latter two cases can be spoken of as “structural or semi-structural” type rupture A whole series of intermediate cases exist which are assessed by percentage of the affected surfaces.

In the case of the laminated composite, said laminate represents the largest part of any GRP piece, it is therefore what confers the mechanical resistance to the molded piece. This requires the elimination of the zones that are poor or rich in resins thanks to a uniform distribution of the resin and of the reinforcement and a rigorous control of the resin/glass ratio. Finally, the number of air cavities or of small surface craters is eliminated with a carefully done “ebullage” which gives this vitrified appearance to the piece. The very closed polyester structure has an influence on the surface characteristics of the composite and consequently on their adhesive behavior.

In order to treat the surfaces of the pieces to be adhesively bonded, there is generally used a solvent, notably methyl ethyl ketone, dichloromethane, acetone which acts as a degreasing agent for the partial solubilization and/or the crude elimination of the internal mold release agents and of the thermoplastic phase present at the surface. This treatment is not however sufficiently effective to avoid a preliminary sanding or abrasion of the pieces to be bonded before the “degreasing,” this mechanical sanding or abrasion operation being the source of dust. The sanding or abrasion are besides rendered more and more difficult by the more and more complex geometries of the pieces to be bonded.

Equally proposed are chemical treatments of the substrate adapted to the adhesives used.

U.S. Pat. No. 5,792,203 describes the use of amine based compositions in a non-volatile fluid solvent in order to promote the adhesive bonding of plastics by means of cyanoacrylate-based adhesive compositions.

U.S. Pat. No. 4,397,707 describes an adhesive bonding process of polyester-based materials by means of a reactive isocyanate/aminoresin coating (urea formaldehyde or melamine formaldehyde).

### SUMMARY AND OBJECTS OF THE INVENTION

The applicant has thus found in a surprising fashion, that the cold use of a liquid composition according to the present invention permitted the avoidance of sanding or abrasion operations, as well as drying before application of the polyurethane-type adhesive.

Thus, the present invention has for its object a composition for the cold preparation of composite materials based on polyester resins in order to improve the surface state of said composite materials for adhesive bonding by means of polyurethane type adhesives comprising:

a) at least one polar aprotic solvent (TPA)

b) at least one ether (TE) chosen from the family of the ethers, of the ether-esters, of the ether-ketones having:

a molar volume less than 200 and preferably less than 160,

a molecule devoid of hydroxyl function, and

c) at least one activator (TA) comprising at least one reactive nitrogenous function of the type —NH₂ and/or —NH— of molar volume less than 100.

### DETAILED DESCRIPTION OF PREFERRED EMBODIMENTS

The composition according to the invention comprises a polar aprotic solvent (TPA) or a mixture of these solvents which are chosen from the group consisting of Dimethylsulfoxide (DMSO), Dimethylformamide (DMF), 1-methyl-2-pyrrolidinone (NMP), N-Methylmorpholine (NMm), γ-Butyrolactone (Blo), Acetonitrile (AcN), Ethylene carbonate and Propylene carbonate.

The composition according to the invention comprises an ether or a mixture of ethers (TE) of which the molar volume is less than 200 and preferably less than 160. By molar volume is understood in the present application the molecular mass/density ratio.

By way of TE, one will cite in a non-limiting manner the ethers: 1,4-Dioxane (Dx), Methyl-tert-butyl-ether (MTBE), Diethylether, Tert-amyl-methylether (TAME), 2-Methoxy-1,3-dioxolane, 1,3,5-Trioxane, Methyl methoxyacetate, Methyl-3-methoxy-propionate (MMP), Dipropyleneglycol dimethylether (DPGDME), Propyleneglycol methyl ether acetate (PGMA), Tetrahydrofuran (THF), Benzyl oxide (BO), Dibenzyl ether (DBE), 1,3-Dimethoxybenzene, 1,4-Dimethoxybenzene, 1,2,3-Trimethoxybenzene, 2-Methoxy-1,3-dioxolane, 1,3-Dioxolane, Anisole, 1,2Dimethoxybenzene, 2-Methoxy-3,4-Dihydropyrane, 2,5-Dimethoxytetrahydrofu ran, Ethyleneglycoldimethylether, 1-tert-butoxy-2-methoxyethane, 1,4-Dioxane, 1,3-Dioxane and their mixtures.

According to a preferred embodiment of the present invention, one will prefer the ethers of flash points greater than 0° C. The high flash point of the Benzyl oxide (BO) or Dibenzyl ether (greater than 100° C.) notably permits the use of temperatures greater than 40° C.

The composition according to the invention comprises an activator or a mixture of activators (TA) comprising one or several reactive nitrogenous functions of the type —NH₂ and/or —NH— chosen in the family of the primary and/or secondary amines of molar volume less than 100. By way of examples of TA compounds, there will notably be cited f: pyrrole, imidazole, 3-pyrroline, pyrazole and 3-pyrroline and their mixtures.

A ternary composition Total Polar Aprotic (TPA)/Total Ether (TE)/Total Activator (TA) is studied, represented on the ternary diagram by the coordinates:

TPA*=[TPA/(TPA+TE+A)]·10²

TE*=[TE/(TPA+TE+A)]·10²

TA*=[TA/(TPA+TE+A)]·10²

where the looping relation is applied at 100% of the composition TPA*+TE*+A*=100, all the amounts TPA, TE, A being expressed by volume, the amounts TPA*, TE* and A appearing as volume percentages.

The compositions of the invention are those that obey the relationships:

10% [TPA*[40%

55% [TE*[85%

1% [TA*[25%

According to a preferred embodiment of the present invention, the solvent or mixture of polar aprotic solvents (TPA), the ether or mixture of ethers (TE) and the activator or mixture of activators (TA) are present in the composition in quantities respectively ranging between 20 and 30%, 65 and 75%, and 2 and 10% by volume.

According to a particularly preferred variant of the invention, the polar aprotic fraction (TPA) is a mixture of Dimethylsulfoxide (DMSO) and of Dimethylformamide (DMF). According to this variant, the voluminal ratio of the mixture is advantageously ranging between 40/60, and preferably is equal to 50/50.

The present invention equally has for its object a process for the cold surface preparation of supports of laminated composite materials for their adhesive bonding comprising treating the surface of said supports with a composition according to the present invention before application of a polyurethane type adhesive.

The preparation of the compositions according to the invention can be done by simple mixing of the different constituents, with the help of an agitator or any other appropriate device.

The process for the preparation of the surface is implemented by depositing the composition according to the present invention on the part of the surface of the object which is to receive the adhesive. The deposit of the composition according to the invention can be made by any means. Among these means, one can cite immersion, spraying, atomization, coating with the help of a brush, a rag or a sponge, etc. The deposit is carried out at a temperature ranging between 5 and 50° C. and advantageously at ambient temperature generally ranging between 15 and 30° C. The contact time before application of the adhesive ranges between 1 and 60 minutes.

The present invention is now described in more detail by the following examples, here for illustration, which are not in any case to be considered as limiting the present invention, for which numerous variations are easily accessible to a person skilled in the art.

### EXAMPLES

In the examples, the breaking pattern of the support by pulling/tearing is characterized starting from a combination of two polyester test pieces charged with glass fiber on the one hand and with GRP of an unsaturated polyester resin base on the other hand. The method comprises cold application (23° C.) of a strand (10 cm×0.8 cm; 1 mm thickness) of the bi-constituent polyurethane type adhesive to one of the two test pieces before bringing it into contact with the second test piece, previously put into contact with a composition according to the invention for at least 1 minute at ambient temperature (23° C.). The assembly of the two test pieces is then allowed to lie in an enclosure at 150° C. for 2 minutes 30. After returning to ambient temperature (23° C.), the assembly is subjected to pulling/tearing stresses until separation of the two test pieces.

The efficacy of the adhesive-support bond is then evaluated by the type of rupture: Adhesive (RA), cohesive (RC), superficial cohesive (RCS) and delaminating of the support (DEL) The cohabitation of the different types of breakage can be observed in the same pulling/tearing test. The ruptures with delamination of the support (DEL or DEL/RC) are desired.

The bi-constituent polyurethane adhesive used to illustrate the invention is an adhesive of the semi-flexible type, which is used at a rate of 100 parts by volume of resin (mixture of polyols) for 100 parts of hardener (mixture of isocyanates). The intimate mixture of the two constituents is obtained thanks to a static mixer connected to a double cartridged spray gun, the assembly currently used for the application of these adhesives.

Different formulations were tested, which permitted demonstrating the synergies existing between the different components of the composition according to the invention.

Hereinafter are given the results obtained by implementing a selection of preferred components alone or in the form of compositions according to the present invention as well as the action of a methyl-ethyl-ketone solution (MEK) according to the prior art.

The analogous effects observed on the SMC test pieces on the one hand and GRP test pieces on the other hand, non-sanded (or non-abraded) in both cases with respect to the tested compositions are as follows:

| | DMSO | | | | |
|---|---|---|---|---|---|
| | (%) | NMP (%) | Ether (%) | OB (%) | Effect |
| Formula 1 | 47.5 | 47.5 | — | 5.0 | RA/RCS |
| Formula 2 | 95.0 | — | — | 5.0 | RA/RCS |
| Formula 3 | 30.0 | — | — | 5.0 | RA/RCS |
| Formula 4 | 15.0 | 15.0 | 70.0 | — | RA/RCS |
| Formula 5 | 12.5 | 12.5 | 70.0 | — | RA/RCS |
| Formula 6 | 12.5 | 12.5 | 65.0 | 10.0 | DEL/RC |
| Formula 7 | 25.0 | 25.0 | 25.0 | 25.0 | DEL |
| Formula 8 | — | — | 100.0 | — | RA/RCS |
| Formula 9 | — | — | 80.0 | 20.0 | RA/RCS |
| Formula 10 | 25.0 | — | 70.0 | 5.0 | RC/RCS/DEL |
| Formula 11 | — | 25.0 | 70.0 | 5.0 | RC/RCS/DEL |

| | DMSO | | | | |
|---|---|---|---|---|---|
| | (%) | NMP (%) | Ether (%) | IM (%) | Effect |
| Formula 12 | 12.5 | 12.5 | 65.0 | 5.0 | DEL/RC |

| | MEK (%) | Effect |
|---|---|---|
| Control 1 | 100.0 | RA/RCS |
| Control 2 | — | RA |

when a polar aprotic solvent or a mixture of polar aprotic solvents is used alone, no improvement with respect to the Controls 1 and 2 is observed.
when an ether or a mixture of ethers is used alone, no improvement with respect to Controls 1 and 2 is observed.
when a polar aprotic solvent or a mixture of polar aprotic solvents is used in combination with an ether or a mixture of ethers, no improvement with respect to Controls 1 and 2 is observed.
when a polar solvent or a mixture of polar solvents is used en combination with an activator or a mixture of activators, no improvement with respect to the Controls 1 and 2 is observed.
when ether or a mixture of ethers is used in combination with an activator or a mixture of activators, no improvement with respect to Controls 1 and 2 is observed.
when a polar aprotic solvent or a mixture of polar aprotic solvents, an ether or a mixture of ethers and an activator or a mixture of activators are associated in the voluminal proportions according to the invention, a clear improvement with respect to Controls 1 and 2 is observed.
when the polar aprotic fraction of a composition according to the invention is composed of a 50/50 mixture of Dimethylsulfoxide (DMSO) and Dimethylformamide (DMF), a slight improvement with respect to the equivalent compositions using only DMSO or DMF is observed.
There can be obtained thanks to the present compositions the best performances (efficacy-flammability). Among these, there will be cited in particular those having a base of benzyl ether or benzyl oxide (BO) whose flash point is greater than 100° C.

What is claimed is:

1. A composition comprising:
(a) at least one polar aprotic solvent (TPA)
(b) at least one ether (TE) selected from the group consisting of ethers, ether-esters, and ether-ketones having:
a molar volume less than 200,
a molecule devoid of a hydroxyl function
(c) at least one activator (TA) comprising at least one reactive —NH₂ and/or —NH— nitrogenous function, of molar volume less than 100.
wherein (a), (b), and (c) are present in proportions effective for cold preparation of laminated composite materials based on polyester resins in order to confer to them without preliminary sanding or abrasion a surface state suitable for adhesive bonding with a polyurethane adhesive.

2. The composition according to claim 1, wherein said molar volume is less than 160.

3. The composition according to claim 1, in which the polar aprotic solvent (TPA) is Dimethylsulfoxide (DMSO), Dimethylformamide (DMF), 1-methyl-2-pyrrolidinone (NMP), N-Methylmorpholine (NMm), γ-Butyrolactone (Blo), Acetonitrile (AcN), Ethylene carbonate or Propylene carbonate.

4. The composition according to claim 1, in which the ether (TE) is 1,4-Dioxane (Dx), Methyl-tert-butyl-ether (MTBE), Diethylether, Tert-amyl-methylether (TAME), 2-Methoxy-1,3-dioxolane, 1,3,5-Trioxane, Methyl methoxyacetate, Methyl-3-methoxy-propionate (MMP), Dipropyleneglycol dimethylether (DPGDME), Propyleneglycol methyl ether acetate (PGMA), Tetrahydrofuran (THF), Benzyl oxide (BO), Dibenzyl ether (DBE), 1,3-Dimethoxybenzene, 1,4-Dimethoxybenzene, 1,2,3-Trimethoxybenzene, 2-Methoxy-1,3-dioxolane, 1,3-Dioxolane, Anisole, 1,2-Dimethoxybenzene, 2-Methoxy-3,4-Dihydropyran, 2,5-Dimethoxytetrahydrofuran, Ethyleneglycoldimethylether, 1-tert-butoxy-2-methoxyethane, 1,4-Dioxane or 1,3-Dioxane.

5. The composition according to claim 1, in which the activator (TA) is pyrrole, imidazole, pyrazole or 3-pyrroline.

6. The composition according to claim 1, wherein Total Polar Aprotic (TPA), Total Ether (TE) and Total Activator (TA) described by the coordinates:
TPA*=[TPA/(TPA+TE+A)]·10²
TE*=[TE/(TPA+TE+A)]·10²
TA*=[TA/(TPA+TE+A)]·10²
are linked to the ternary diagram by the relations:
10% [TPA*[40%
55% [TE*[85%
1% [TA*[25%
where the looping relation is applied to 100% of the composition TPA*+TE*+A*=100, all the amounts TPA, TE, A being expressed by volume, the amounts TPA*, TE* and A appearing as volume percentages.

7. The composition according to claim 1, in which the polar aprotic solvent (TPA) is a mixture of Dimethylsulfoxide (DMSO) and Dimethylformamide (DMF) in a voluminal ratio ranging between 40/60 and 60/40.

8. The composition according to claim 7, wherein said voluminal ratio of said mixture is equal to 50/50.

9. The composition according to claim 1, in which the ether (TE) is an ether having a flash point greater than 100° C.

10. The composition according to claim 9, wherein the ether (TE) is benzyl oxide (BO) or Dibenzyl ether.

11. The composition according to claim 1, in which the ether (TE) comprises one or more methoxy groups.

12. A laminate composite comprising:
(a) two or more polyester-based resin layers; each of said layers including at least one surface which is adhesively bound to a surface of another layer, wherein said surface is not sanded or abraded;
(b) a polyurethane adhesive between the surfaces of said layers which are adhesively bound,
wherein said surfaces of said layers which are adhesively bound are pre-treated with the composition according to claim 1 prior to application of the adhesive.

13. A process for preparation of the composition according to claim 1, comprising simple mixing of components (a)-(c).

14. A process for cold preparation of surfaces of materials for adhesive bonding, used to form a laminated composite, comprising treating the surfaces of said materials with the composition according to claim 1.

15. The process according to claim 14, wherein said composite materials are SMC (Sheet Molding Compounds), BMC (Bulk Molding Compounds), RTM (Resin Transfer Molding), AMC (Adapted Molding Compound), or RIM (Resin Injection Molding) materials.

16. The process according to claim 14, wherein said composite materials are laminated materials of the GRP (Glass Reinforced Plastic) or FRP (Fiber Reinforced Polymers) type based on a resin of unsaturated polyesters.

17. The process according to claim 14, comprising treating the surface to be adhesively bonded at a temperature between 5 and 50° C.

18. The process according to claim 17, comprising treating the surface at a temperature between 15 and 30° C.

19. The process according to claim 14, further comprising applying an adhesive less than 60 minutes after treating the surfaces of said materials with the composition according to the invention without previous drying of the treated surfaces.

20. The process according to claim 14, comprising treating the surfaces of said materials by immersion, spraying, or coating with a brush, a rag or a sponge.

21. The process according to claim 14, comprising treating the surfaces of the materials before adhesive bonding or assembling with a polyurethane adhesive.

22. The process according to claim 21, wherein the polyurethane adhesive is of the mono-component (PU1K or HMPUR) or bi-component (PU2K) type.
